(19) United States
(12) Patent Application Publication
(10) Pub. No.: US 2003/0210228 A1
(43) Pub. Date: Nov. 13, 2003

(54) Augmented reality situational awareness system and method

(76) Inventors: John Franklin Ebersole, Bedford, NH (US); John Franklin Ebersole JR., Bedford, NH (US)

Correspondence Address: Brian M. Dingman, Esq., Mirick, O'Connell, DeMallie & Lougee, LLP, 1700 West Park Drive, Westborough, MA, 01581, US

(21) Appl. No.: 10/403,249

(22) Filed: Mar. 31, 2003

Related U.S. Application Data
(63) Continuation-in-part of application No. 09/513,152, filed on Feb. 25, 2000, now Pat. No. 6,578,017.
(63) Continuation-in-part of application No. 09/634,203, filed on Aug. 9, 2000, now abandoned.
(63) Continuation-in-part of application No. 10/215,567, filed on Aug. 9, 2002.
(63) Continuation-in-part of application No. 10/216,304, filed on Aug. 9, 2002, now abandoned.

(51) Int. Cl. G09G 5/08

(52) U.S. Cl. 345/157

(57) ABSTRACT

Method and apparatus are presented for prioritizing and assessing navigation data using an Augmented Reality navigation aid. Navigators are often placed in treacherous, unfamiliar, or low-visibility situations. An augmented reality navigation aid is used to overlay relevant computer-generated images, which are anchored to real-world locations of hazards, onto one or more users' field of view. Areas of safe passage for transportation platforms such as ships, land vehicles, and aircraft can be displayed via computer-generated imagery or inferred from various attributes of the computer-generated display. The invention is applicable to waterway navigation, land navigation, and to aircraft navigation (for aircraft approaching runways or terrain in low visibility situations). A waterway embodiment of the invention is called WARN™, or Waterway Augmented Reality Navigation™.

A method is presented for visualization of hazards which pose a serious threat to those in the immediate vicinity. Such hazards include, but are not limited to, fire, smoke, radiation, and invisible gasses. The method utilizes augmented reality, which is defined as the mixing of real world imagery with computer-generated graphical elements.

Computer-generated three-dimensional representations of hazards can be used in training and operations of emergency first responders and others. The representations can be used to show the locations and actions of a variety of dangers, real or computer-generated, perceived or not perceived, in training or operations settings. The representations, which may be graphic, iconic, or textual, are overlaid onto a view of the user's real world, thus providing a reality augmented with computer-generated hazards. A user can then implement procedures (training and operational) appropriate to the hazard at hand.

A method is presented which uses Augmented Reality for visualization of text and other messages sent to an EFR by an incident commander. The messages are transmitted by the incident commander via a computer at the scene to an EFR/trainee in an operational or training scenario. Messages to an EFR/trainee, including (but not limited to) iconic representation of hazards, victims, structural data, environmental conditions, and exit directions/locations, are superimposed right onto an EFR/trainee's view of the real emergency/fire and structural surroundings. The primary intended applications are for improved safety for the EFR, and improved EFR-incident commander communications both on-scene and in training scenarios.

### CROSS-REFERENCE TO RELATED APPLICATIONS

This application is a Continuation in Part of

“Method to Aid Object Detection in Images by Incorporating Contextual Information” Ser. No. 09/513,152 filed Feb. 25, 2000;

“Augmented Reality Navigation Aid” Ser. No. 09/634,203 filed Aug. 9, 2000;

“Method for Visualization of Hazards Utilizing Computer-Generated Three-Dimensional Representations” Ser. No. 10/215,567 filed Aug. 9, 2002; and,

“Method for Displaying Emergency First Responder Command, Control, and Safety Information Using Augmented Reality” Ser. No. 10/216,304 filed Aug. 9, 2002.

### REFERENCES CITED

U.S. Patent Documents

| | | |
|---|---|---|
| 5,815,411 | Sep. 29, 1998 | Ellenby, et al . . . 702/150 |
| 6,094,625 | Jul. 25, 2000 | Ralston . . . 702/150 |
| 5,815,126 | Sep. 29, 1998 | Fanetal. . . . 345/8 |
| 6,101,431 | Aug. 8, 2000 | Niwa et al. . . . 340/980 |
| 6,057,786 | May 2, 2000 | Briffe et al. . . . 340/974 |
| 6,175,343 | 345/7 | Mitchell et al. . . . 345/7 |

### FIELD OF THE INVENTION

This technology relates to the fields augmented reality (AR) and situational awareness. The purpose of the invention is to increase situational awareness by providing a method by which a display of computer-generated imagery is combined with a view of the real world in order to allow a user to “see” heretofore unseen, otherwise invisible, objects. The AR technology of this invention has multiple applications, including but not limited to, navigation, firefighter and other emergency first responder (EFR) training and operations, and firefighter and other EFR safety.

### COPYRIGHT INFORMATION

A portion of the disclosure of this patent document contains material that is subject to copyright protection. The copyright owner has no objection to the facsimile reproduction by anyone of the patent document or the patent disclosure as it appears in the Patent and Trademark Office records but otherwise reserves all copyright works whatsoever.

### BACKGROUND OF THE INVENTION

The need to “see” one or more otherwise invisible or unseen objects is present in many professions. Augmented reality (AR) is frequently used to accommodate this need. Broadly, AR is the combination of real world and computer-generated (virtual) elements such that a user is presented with a display whereby the computer-generated elements are overlaid onto a view of the real world. Many methods, most of which use AR, are available and applicable to different professions, and allow visualization of real objects which may be hidden from a user's view. Ralston (U.S. Pat. No. 6,094,625) describes a method surveyors can use to view computer-generated simulations of unseen objects (underground or otherwise), alphanumeric displays, or virtual survey poles. Ralston's method is limited in that the virtual elements are static in nature (they do not move, flash, twinkle, etc.). Fan, et al. (U.S. Pat. No. 5,815,126) describe a head-mounted portable communication and display system. The limitations of this system are similar to Ralston's: the display of the virtual elements is static in nature. Ellenby, et al. (U.S. Pat. No. 5,815,411), Mitchell, et al. (U.S. Pat. No. 6,175,343), and Niwa (U.S. Pat. No. 6,101,431) describe systems which have use in many applications. The virtual elements in these systems can display movement; however, the virtual elements do not display in such a manner as to indicate intensity of implied level of danger. Finally, while Briffe, et al. (U.S. Pat. No. 6,057,786) describe a cockpit display system, no mention is made of virtual or augmented reality. All referenced methods cite use in actual operations. Current navigation systems often require navigators to take their eyes away from the outside world to ascertain their position and the relative positions of hazards. For example, the latest ship navigation aids employ Differential Global Positioning System (DGPS) technology and computerized maps which present the navigator with a display of the ship's location and surrounding areas. To remedy this shortcoming, we present an AR navigation system that will allow the navigator to simultaneously see dynamically-updated navigation information mixed with a live view of the real world. Additionally, this AR navigation technology will be customizable by the navigator.

Today's emergency first responders (hereafter referred to as EFRs) may be dispatched to highly dangerous scenes which visually appear to be relatively normal. For example, certain chemical compounds involved in a spill situation can transform into invisible, odorless gas, yet potentially be harmful to EFR personnel and victim(s). There are also types of hazards which may not be visible at any stage (e.g., radiation leaks) that pose a serious threat to those in the immediate vicinity. In order to prepare EFRs for these types of incidents, these situations must be anticipated and presented within the training environment. Furthermore, in order to maintain a high level of proficiency in these situations, frequent re-education of professionals within first responder fields is called for to ensure that proper procedures are readily and intuitively implemented in a crisis situation.

A key feature of the AR situational awareness system and method described herein is the ability to effectively “cut through” fog, smoke, and smog with a computer overlay of critical information. The system allows navigators, for example, to be aware of hazards in low-visibility conditions, as well as in dawn, dusk, and nighttime operations. The navigator is also able to visualize “hidden hazards” because he/she can “see through” objects such as geographical features (e.g., bends in a river), other ships, and the navigator's own ship while docking. The system also displays previously identified subsurface hazards such as sandbars, shallow waters, reefs, or sunken ships. Furthermore, the computer-generated virtual elements have elements which indicate the intensity and/or danger level of an object and, communicate the integrity of the data being displayed. For example, an emergency first responder (EFR) using the method described will be able to “see” an invisible gas in a hazmat situation. Not only can the user “see the unseen”, the user can also determine from the display which area of the incident is most dangerous and which is safest.

The navigation embodiment of AR situational awareness system described herein may improve the cost-effectiveness and safety of commercial shipping. For example, our system can increase the ton-mileage of ships navigating narrow channels in low visibility, as well as extend the navigation season by using AR buoys in place of real buoys when the use of real buoys is prevented by ice formation. The US Coast Guard has set up DGPS transmitters for navigation of coastal waterways (Hall, 1999). DGPS coastal navigation systems have a requirement to be accurate to within 10 meters, and good DGPS systems are accurate to 1 meter. Recently, the degradation of the GPS signal that made commercial-grade GPS units less accurate has been removed, making GPS readings more accurate without the aid of DGPS. The invention makes use of this ubiquitous technology.

The system described herein has use in both operations and training. Navigators, for example, will be able to train for difficult docking situations without being actually exposed to those risks. Additionally, current EFR training is limited to traditional methods such as classroom/videotape and simulations such as live fire scenarios. Classroom and videotape training do not provide an environment which is similar to an actual incident scene; therefore, a supplementary method is required for thorough training. Simulations are done via simulator equipment, live fire, and/or virtual reality. Simulations using live fire and other materials can pose unacceptable risk to trainees and instructors; other types of simulations may occur within an environment which is not realistic enough to represent an actual incident scene.

An EFR/trainee able to “see” invisible or otherwise unseen potentially hazardous phenomena will be better able to implement the correct procedures for dealing with the situation at hand. This application describes a method, which is “harmless” to the EFR/trainee, for visualizing unseen hazards and related indicators. Operational and training settings implementing this method can offer EFRs/trainees the ability to “see” hazards, safe regions in the vicinity of hazards, and other environmental characteristics through use of computer-generated three-dimensional graphical elements. Training and operational situations for which this method is useful include, but are not limited to, typical nuclear, biological, and chemical (NBC) attacks, as well as hazardous materials incidents and training which require actions such as avoidance, response, handling, and cleanup.

The method described herein represents an innovation in the field of EFR training and operations. The purpose of this method is twofold: safe and expeditious EFR passage through/around the hazard(s); and safe and efficient clean up/removal training and operations.

An incident commander or captain outside a structure where an emergency is taking place must be in contact with firefighters/emergency first responders (hereafter collectively referred to as EFRs) inside the structure for a number of reasons: he/she may need to transmit information about the structure to the EFR so a hazard, such as flames, can safely be abated; he/she may need to plot a safe path through a structure, avoiding hazards such as fire or radiation, so that the EFR can reach a destination safely and quickly; or he/she may need to transmit directions to an EFR who becomes disoriented or lost due to smoke or heat. Similarly, these and other emergency situations must be anticipated and prepared for in an EFR training environment.

One of the most significant and serious problems at a fire scene is that of audio communication. It is extremely difficult to hear the incident commander over a radio amidst the roar of flames, water and steam. If, for example, the commander was trying to relay a message to a team member about the location of a hazard inside the structure, there may be confusion due to not being able to clearly understand the message because of the level of noise associated with the fire and the extinguishing efforts. This common scenario places both EFRs and victim(s) at unacceptable risk.

The incident commander is also receiving messages from the EFRs. Unfortunately, the EFRs often have difficulty receiving messages from each other. With a technology in place that allows for easy communication between the incident commander and the EFRs, the incident commander can easily relay messages back to the other members of the EFR team. This allows EFRs to receive messages relevant to each other without having to rely on direct audio communication between EFRs.

### SUMMARY OF THE INVENTION

Augmented reality (AR) is defined in this application to mean combining computer-generated graphical elements with a real world view (which may be static or changing) and presenting the combined view as a replacement for the real world image. This invention utilizes AR technology to overlay a display of otherwise invisible dangerous materials/hazards/other objects onto the real world view in an intuitive, user-friendly format. The display may be in the form of solid object, wireframe representation, icons, text and fuzzy regions which are anchored to real-world locations. The goal is to improve situational awareness of the user by integrating data from multiple sources into such a display, and dynamically updating the data displayed to the user.

This invention will allow safer navigation of platforms (e.g., ships, land vehicles, or aircraft) by augmenting one or more human's view with critical navigation information. A strong candidate for application of this technology is in the field of waterway navigation, where navigation is restricted by low visibility and, in some locations, by a short navigation season due to cold-weather and potentially ice-bound seaways. This invention could allow waterway travel to continue on otherwise impassable days. Other candidates for this technology include navigation on land and navigation of aircraft approaching runways and terrain in low visibility conditions.

Additionally, the invention could allow firefighters and EFRs to receive and visualize text messages, iconic representations, and geometrical visualizations of a structure as transmitted by an incident commander from a computer or other device, either on scene or at a remote location.

Additionally, these computer-generated graphical elements can be used to present the EFR/trainee/other user with an idea of the extent of the hazard at hand. For example, near the center of a computer-generated element representative of a hazard, the element may be darkened or more intensely colored to suggest extreme danger. At the edges, the element may be light or semitransparent, suggesting an approximate edge to the danger zone where effects may not be as severe.

Using hardware technology available today that allows EFRs to be tracked inside a building, the invention is able to have the EFRs' locations within a structure displayed on a computer display present at the scene (usually in one of the EFR vehicles). This information allows an incident commander to maintain awareness of the position of personnel in order to ensure the highest level of safety for both the EFR(s) and for any victim(s). Instead of relying on audio communication alone to relay messages to the incident team, the commander can improve communication by sending a text or other type of message containing the necessary information to members of the incident team. Furthermore, current positional tracking technology can be coupled with an orientation tracker to determine EFR location and direction. This information would allow the incident commander to relay directional messages via an arrow projected into a display device, perhaps a display integrated into a firefighter's SCBA (Self Contained Breathing Apparatus). These arrows could be used to direct an EFR toward safety, toward a fire, away from a radiation leak, or toward the known location of a downed or trapped individual. Other iconic messages could include graphics and text combined to represent a known hazard within the vicinity of the EFR, such as a fire or a bomb.

This data may be presented using a traditional interface such as a computer monitor, or it may be projected into a head-mounted display (HMD) mounted inside an EFR's mask, an SCBA (Self-Contained Breathing Apparatus), HAZMAT (hazard materials) suit, or a hardhat. Despite the method of display, the view of the EFR/trainee's real environment, including visible chemical spills, visible gasses, and actual structural surroundings, will be seen, overlaid or augmented with computer-generated graphical elements (which appear as three-dimensional objects) representative of the hazards. The net result is an augmented reality.

This invention can notably increase the communication effectiveness at the scene of an incident or during a training scenario and result in safer operations, training, emergency response, and rescue procedures.

The invention has immediate applications for both the training and operations aspects of the field of emergency first response; implementation of this invention will result in safer training, retraining, and operations for EFRs involved in hazardous situations. Furthermore, potential applications of this technology include those involving other training and preparedness (i.e., fire fighting, damage control, counter-terrorism, and mission rehearsal), as well as potential for use in the entertainment industry.

### BRIEF DESCRIPTION OF THE DRAWINGS

FIG. 1 is a block diagram indicating the hardware components and interconnectivity of a see-through augmented reality (AR) system.

FIG. 2 is a block diagram indicating the hardware components and interconnectivity of a video-based AR system involving an external video mixer.

FIG. 3 is a block diagram indicating the hardware components and interconnectivity of a video-based AR system where video mixing is performed internally to a computer.

FIG. 4 is a diagram illustrating the technologies required for an AR waterway navigation system.

FIG. 5 is a block diagram of the components of an embodiment of an AR waterway navigation system.

FIG. 6 is a block diagram of a dynamic situational awareness system.

FIG. 7 is a diagram indicating a head-worn display embodiment for an AR waterway navigation system.

FIG. 8 is a diagram indicating a handheld display embodiment for an AR waterway navigation system.

FIG. 9 is a diagram indicating a heads-ups display embodiment for one or more users for an AR waterway navigation system.

FIG. 10 is an example of an opaque or solid AR graphic overlay.

FIG. 11 is an example of a display that contains multiple opaque or solid graphic in the AR overlay.

FIG. 12 is an example of a semi-transparent AR graphic overlay.

FIG. 13 is an example of an AR overlay in which the graphics display probability through use of color bands and alphanumeric elements.

FIG. 14 is an example of an AR overlay in which the graphics display probability through use of color bands, alphanumeric elements and triangular elements.

FIG. 15 represents the concept of an augmented reality situational awareness system for navigation.

FIG. 16 is the same scene as 15C, but with a wireframe AR overlay graphic for aid in ship navigation.

FIG. 17 is an AR scene where depth information is overlaid on a navigator's viewpoint as semi-transparent color fields.

FIG. 18 is an overlay for a land navigation embodiment of the invention.

FIG. 19 contains diagrams of overlays for an air navigation embodiment of the invention.

FIG. 20 depicts an augmented reality display according to the invention that displays a safe path available to the user by using computer-generated graphical poles to indicate where the safe and dangerous regions are.

FIG. 21 depicts an augmented reality display according to the invention that depicts a chemical spill emanating from a center that contains radioactive materials.

FIG. 22 depicts an augmented reality display according to the invention that depicts a chemical spill emanating from a center that contains radioactive materials.

FIG. 23 is a schematic diagram of the system components that can be used to accomplish the preferred embodiments of the inventive method.

FIG. 24 is a conceptual drawing of a firefighter's SCBA with an integrated monocular eyepiece that the firefighter may see through.

FIG. 25 is a view as seen from inside the HMD of a text message accompanied by an icon indicating a warning of flames ahead

FIG. 26 is a possible layout of an incident commander's display in which waypoints are placed.

FIG. 27 is a possible layout of an incident commander's display in which an escape route or path is drawn.

FIG. 28 is a text message accompanied by an icon indicating that the EFR is to proceed up the stairs.

FIG. 29 is a waypoint which the EFR is to walk towards.

FIG. 30 is a potential warning indicator warning of a radioactive chemical spill.

FIG. 31 is a wireframe rendering of an incident scene as seen by an EFR.

FIG. 32 is a possible layout of a tracking system, including emitters and receiver on user.

### DETAILED DESCRIPTION OF THE INVENTION

Overview of AR Systems

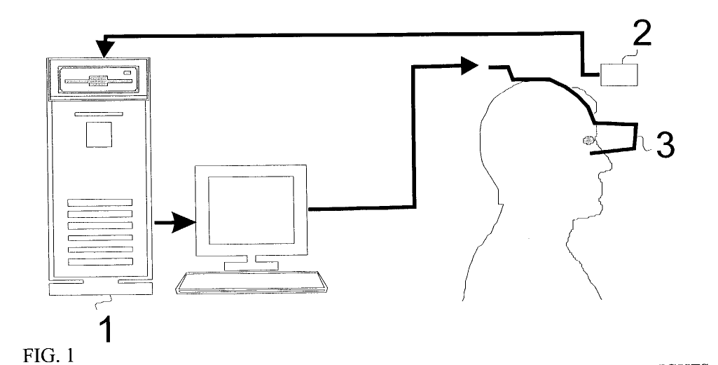

As shown in FIG. 1, the hardware for augmented reality (AR) consists minimally of a computer 1, see-through display 3, and motion tracking hardware 2. In such an embodiment, motion tracking hardware 2 is used to determine the human's head position and orientation. The computer 1 in FIGS. 1-3 is diagrammed as, but not limited to, a desktop PC. Lightweight, wearable computers or laptops/notebooks may be used for portability, high-end graphics workstations may be used for performance, or other computing form factors may be used for the benefits they add to such a system. The computer 1 (which can be a computer already installed on a ship as part of a traditional navigation system) uses the information from the motion tracking hardware 2 in order to generate an image which is overlaid on the see-though display 3 and which appears to be anchored to a real-world location or object. This embodiment is preferred as it has less equipment and can allow for a better view of the real world.

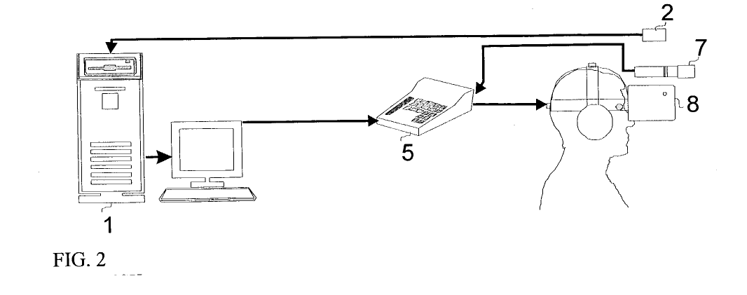

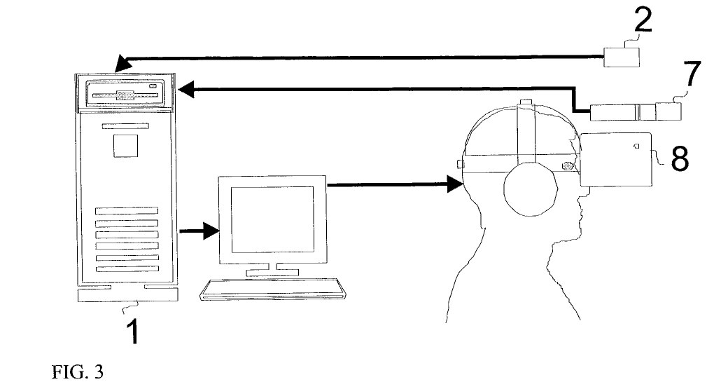

Other embodiments of AR systems include video-based (non-see-through) hardware, as shown in FIG. 2 and in FIG. 3. In addition to using motion tracking equipment 2 and a computer 1, these embodiments utilize a camera 7 to capture the real-world imagery and non-see-through display 8 for displaying computer-augmented live video.

One embodiment, shown in FIG. 2, uses an external video mixer 5 to combine computer-generated imagery with live camera video via a luminance key or chroma key with computer-generated (CG) output that has been converted to NTSC using VGA-to-NTSC encoder (not shown). Two cameras (not shown) can be used for stereo imagery. The luminance key removes white portions of the computer-generated imagery and replaces them with the camera imagery. Black computer graphics remain in the final image, and luminance values for the computer graphics in between white and black are blended appropriately with the camera imagery. The final mixed image (camera video combined with computer graphics) is displayed to a user in head-mounted display (HMD) 8. The position tracker 2 attached to the video camera 7 is used by the computer 1 to determine the position and orientation of the viewpoint of the camera 7, and the computer 1 will render graphics to match the position and orientation.

The second video-based embodiment, shown in FIG. 3, involves capturing live video in the computer 1 with a frame grabber and overlaying opaque or semi-transparent imagery internal to the computer. Another video-based embodiment (not shown) involves a remote camera. In this embodiment, motion tracking equipment 2 can control motors that orient a camera which is mounted onto a high-visibility position on a platform, allowing an augmented reality telepresence system.

Position Tracking

The position and orientation of a user's head (or that of the display device) in the real world must be known so that the computer can properly register and anchor virtual (computer-generated) objects to the real environment.

In a navigation embodiment of the inventive method, there must be a means of determining the position of the navigator's display device (head worn or otherwise carried or held) in the real world (i.e., the navigator's point of view in relation to the platform—which may or may not be moving—and to his/her other surroundings). The preferred embodiment of motion tracking hardware for a navigation embodiment is a hybrid system which fuses data from multiple sources to produce accurate, real-time updates of the navigator's head position and orientation. Specifically, information on platform position and/or orientation gathered from one source may be combined with position and orientation of the navigator's display device relative to the platform and/or world gathered from another source in order to determine the position and orientation of the navigator's head relative to the outside (real) world. The advantage of an embodiment using a hybrid tracking system is that it allows the navigator the flexibility to use the invention from either a fixed (permanent or semi-permanent) location or from varied locations on the platform. Furthermore, a hybrid tracking system allows outdoor events and objects to be seen while the navigator is “indoors” (e.g., on the bridge inside a ship) or outside (e.g., on the deck of a ship).

In an embodiment of the inventive method used by EFRs, the position of the EFR may already be tracked at the scene by commonly used equipment. In addition to determining where the EFR is, the position and orientation of the display device (which may be mounted inside a firefighter's SCBA, a hardhat or other helmet, or a hazmat suite) relative to the surroundings must also be determined. There are numerous ways to accomplish this, including a Radio Frequency technology based tracker, inertial tracking, GPS, magnetic tracking, optical tracking or a hybrid of multiple tracking methods.

Platform Tracking—GPS/DGPS

The first part of a hybrid tracking system for the navigation embodiment of this invention consists of tracking the platform. One embodiment of the invention uses a single GPS or DGPS receiver system to provide 3 degrees-of-freedom (DOF) platform position information. Another embodiment uses a two-receiver GPS or DGPS system to provide platform's heading and pitch information in addition to position (5-DOF). Another embodiment uses a three-receiver GPS or DGPS system to provide 6-DOF position and orientation information of the platform. In each embodiment, additional tracking equipment is required to determine, in real-time, a navigator's viewpoint position and orientation for registration and anchoring of the computer-generated imagery.

Head and/or AR Display Device Tracking: GPS Only (Non-Hybrid)

The simplest embodiment of tracking for AR platform navigation would be to track the platform position with three receivers and require the navigator's head (or the AR display device) to be in a fixed position on the platform to see the AR view. An example of this embodiment includes a see-through AR display device for use by one or more navigators mounted in a stationary location relative to the platform.

Head and/or AR Display Device Tracking: One GPS/DGPS Receiver (Hybrid)

In the navigation embodiment of the invention where a single GPS or DGPS receiver is used to provide platform position information, the navigator's head position (or the position of the AR display device) relative to the GPS/DGPS receiver and the orientation of the navigator's head (or the AR display device) in the real world must be determined in order to complete the hybrid tracking system. An electronic compass (or a series of GPS/DGPS positions as described below) can be used to determine platform heading in this embodiment, and an inertial sensor attached to the display unit can determine the pitch and roll of the navigator's head or the AR display device. Additionally, a magnetic, acoustic, or optical tracking system attached to the display unit can be used to track the position and orientation of the navigator's head relative to the platform. This embodiment affords the navigator the flexibility to remain in a fixed position on the platform or to move and/or move the AR display device to other locations on the platform.

Head and/or Display Device Tracking: Two GPS/DGPS Receivers (Hybrid)

In a navigation embodiment consisting of two GPS/DGPS receivers, platform heading and position can both be determined without an electronic compass. The hybrid tracking system would still require an inertial or other pitch and roll sensor to determine position and orientation of the platform and a magnetic, acoustic, or optical tracking system in order to determine the real-world position and orientation of the navigator's viewpoint in relation to the platform. This embodiment also allows the navigator to use the invention while in either a fixed location or while at various locations around the platform.

Head and/or Display Device Tracking: Three GPS/DGPS Receivers (Hybrid)

A three GPS/DGPS receiver embodiment requires only the addition of 6-DOF motion tracking (of the navigator's head and/or the AR display device) relative to the platform. This can be accomplished with magnetic, acoustic, or optical tracking. Once again, due to the hybrid tracking in this embodiment, the navigator may remain in a fixed position on the platform or may move and/or move the AR display device to various locations on the platform.

Update Rates

The update rate (often 1 to 10 Hz) of a platform's GPS/DGPS system is likely not sufficient for continuous navigator viewpoint tracking, so some means of maintaining a faster update rate is required. Inherent in the three hybrid tracking embodiments presented here is a fast-updating head position and orientation tracking system. GPS measurements can be extrapolated in between updates to estimate platform position, and a fast updating system can be responsive to the head movements of the navigator. Alternatively, an inertial sensor attached to the platform can provide fast updates that are corrected periodically with GPS information.

Head and/or Display Device Tracking: Radio Frequency (RF) Technology-Based Tracker

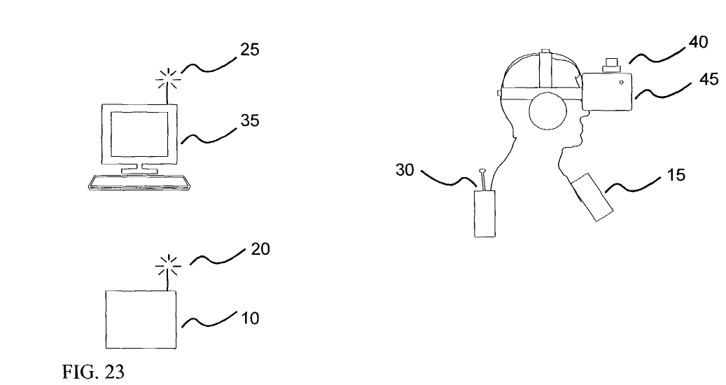

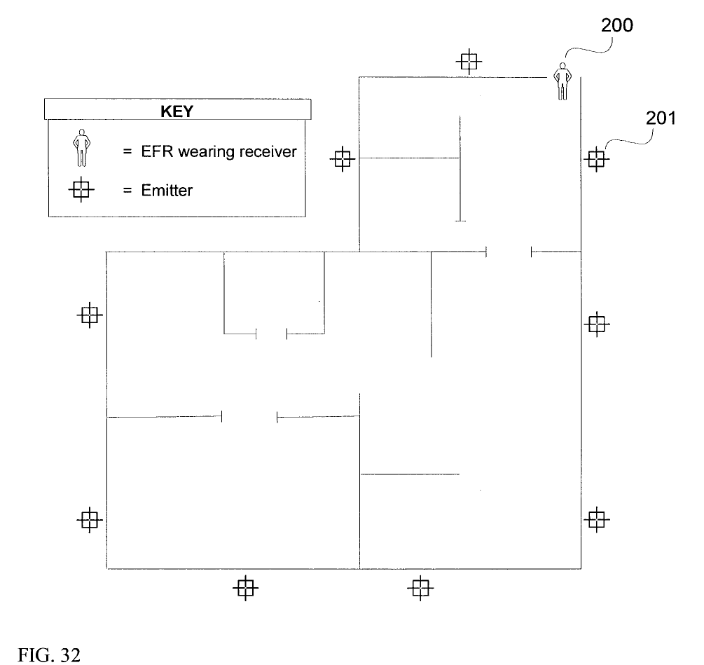

In an EFR embodiment of the invention as shown in FIG. 23, the position of an EFR display device 15, 45 is tracked using a wide area tracking system. This can be accomplished with a Radio Frequency (RF) technology-based tracker. The preferred EFR embodiment would use RF transmitters. The tracking system would likely (but not necessarily) have transmitters installed at the incident site 10 as well as have a receiver 30 that the EFR would have with him or her. This receiver could be mounted onto the display device, worn on the user's body, or carried by the user. In the preferred EFR embodiment of the method (in which the EFR is wearing an HMD), the receiver is also worn by the EFR 40. The receiver is what will be tracked to determine the location of the EFR's display device. Alternately, if a hand-held display device is used, the receiver could be mounted directly in or on the device, or a receiver worn by the EFR could be used to compute the position of the device. One possible installation of a tracking system is shown in FIG. 32. Emitters 201 are installed on the outer walls and will provide tracking for the EFR 200 entering the structure.

To correctly determine the EFR's location in three dimensions, the RF tracking system must have at least four non-coplanar transmitters. If the incident space is at or near one elevation, a system having three tracking stations may be used to determine the EFR's location since definite knowledge of the vertical height of the EFR is not needed, and this method would assume the EFRs are at coplanar locations. In any case, the RF receiver would determine either the direction or distance to each transmitter, which would provide the location of the EFR. Alternately, the RF system just described can be implemented in reverse, with the EFR wearing a transmitter (as opposed to the receiver) and using three or more receivers to perform the computation of the display location.

Head and/or Display Device Tracking: Other Methods

In the EFR embodiment of the invention, the orientation of the EFR display device can be tracked using inertial or compass type tracking equipment, available through the INTERSENSE CORPORATION (Burlington, Mass.). If a HMD is being used as a display device, orientation tracker 40 can be worn on the display device or on the EFR's head. Additionally, if a hand-held device is used, the orientation tracker could be mounted onto the hand-held device. In an alternate EFR embodiment, two tracking devices can be used together in combination to determine the direction in which the EFR display device is pointing. The tracking equipment could also have a two-axis tilt sensor which measures the pitch and roll of the device.

Alternately to the above EFR embodiments for position and orientation tracking, an inertial/ultrasonic hybrid tracking system, a magnetic tracking system, or an optical tracking system can be used to determine both the position and orientation of the device. These tracking systems would have parts that would be worn or mounted in a similar fashion to the preferred EFR embodiment.

Communication Between System Users

In the preferred embodiments, users of the invention may also communicate with other users, either at a remote location or at a location local to the system user.

Use in EFR Scenarios

As shown in FIG. 23, after the position and orientation of the EFR's display device is determined, the corresponding data can be transmitted to an incident commander by using a transmitter 20 via Radio Frequency Technology. This information is received by a receiver 25 attached to the incident commander's on-site laptop or portable computer 35.

The position and orientation of the EFR display device is then displayed on the incident commander's on-site, laptop or portable computer. In the preferred embodiment, this display may consist of a floor plan of the incident site onto which the EFR's position and head orientation are displayed. This information may be displayed such that the EFR's position is represented as a stick figure with an orientation identical to that of the EFR. The EFR's position and orientation could also be represented by a simple arrow placed at the EFR's position on the incident commander's display.

The path which the EFR has taken may be tracked and displayed to the incident commander so that the incident commander may “see” the route(s) the EFR has taken. The EFR generating the path, a second EFR, and the incident commander could all see the path in their own displays, if desired. If multiple EFRs at an incident scene are using this system, their combined routes can be used to successfully construct routes of safe navigation throughout the incident space. This information could be used to display the paths to the various users of the system, including the EFRs and the incident commander. Since the positions of the EFRs are transmitted to the incident commander, the incident commander may share the positions of the EFRs with some or all members of the EFR team. If desired, the incident commander could also record the positions of the EFRs for feedback at a later time.

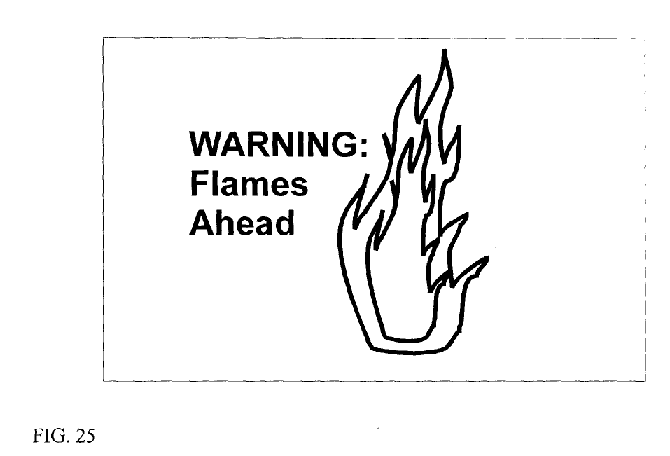

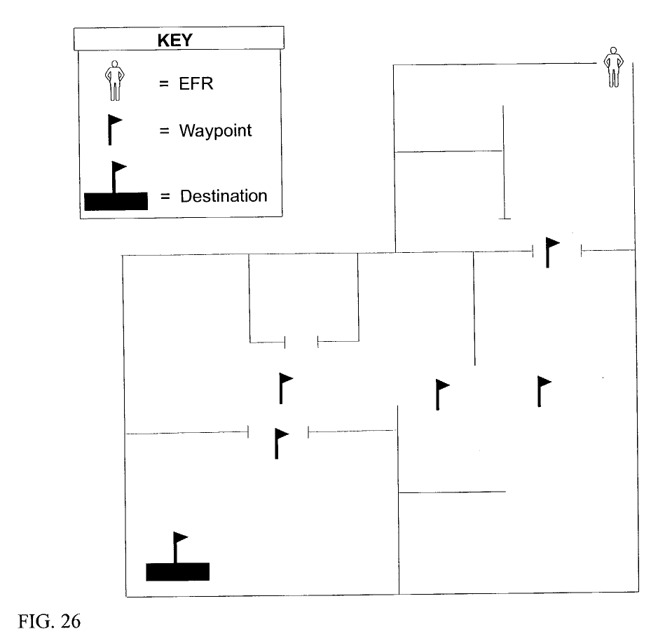

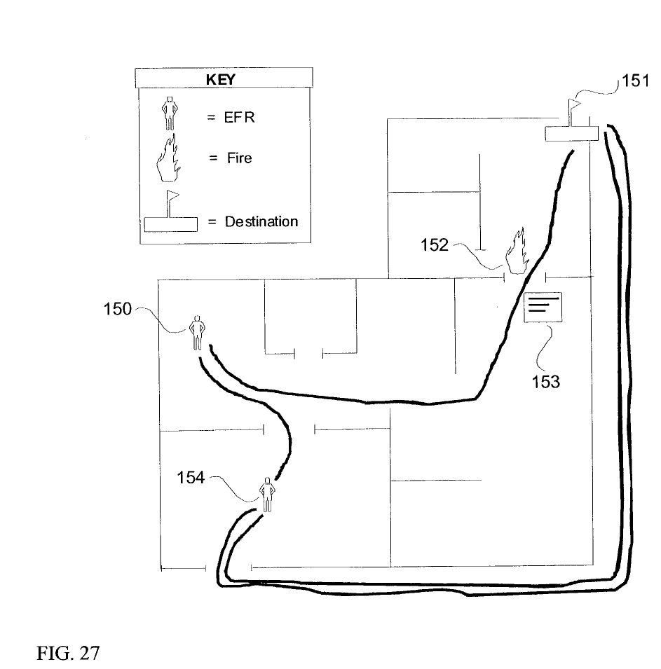

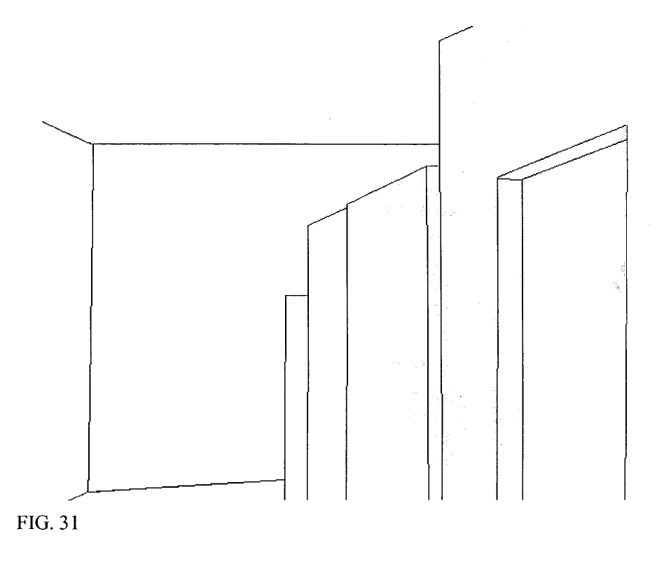

Based on the information received by the incident commander regarding the position and orientation of the EFR display device, the incident commander may use his/her computer (located at the incident site) to generate messages for the EFR. The incident commander can generate text messages by typing or by selecting common phrases from a list or menu. Likewise, the incident commander may select, from a list or menu, icons representing situations, actions, and hazards (such as flames or chemical spills) common to an incident site. FIG. 25 is an example of a mixed text and iconic message relating to fire. If the incident commander needs to guide the EFR to a particular location, directional navigation data, such as an arrow, can be generated to indicate in which direction the EFR is to proceed. The incident commander may even generate a set of points in a path (“waypoints”) for the EFR to follow to reach a destination. As the EFR reaches consecutive points along the path, the previous point is removed and the next goal is established via an icon representing the next intermediate point on the path. The final destination can also be marked with a special icon. See FIG. 26 for a diagram of a structure and possible locations of waypoint icons used to guide the EFR from entry point to destination. The path of the EFR 154 can be recorded, and the incident commander may use this information to relay possible escape routes, indicators of hazards 152, 153, and a final destination point 151 to one or more EFRs 150 at the scene (see FIG. 26). Additionally, the EFR could use a wireframe rendering of the incident space (FIG. 31 is an example of such) for navigation within the structure. The two most likely sources of a wireframe model of the incident space are (1) from a database of models that contain the model of the space from previous measurements, or (2) by equipment that the EFRs can wear or carry into the incident space that would generate a model of the room in real time as the EFR traverses the space.

The incident commander will then transmit, via a transmitter and an EFR receiver, the message (as described above) to the EFR's computer. This combination could be radio-based, possibly commercially available technology such as wireless ethernet.

Display Device Hardware Options

The inventive method requires a display unit in order for the user to view computer-generated graphical elements representative of hazards overlaid onto a view of the real world—the view of the real world is augmented with the representations of hazards. The net result is an augmented reality.

Four display device options have been considered for this invention.

Head-Mounted Displays (HMDs)

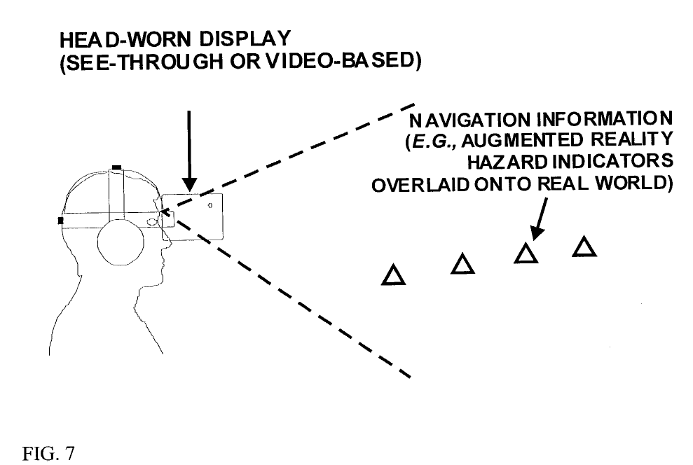

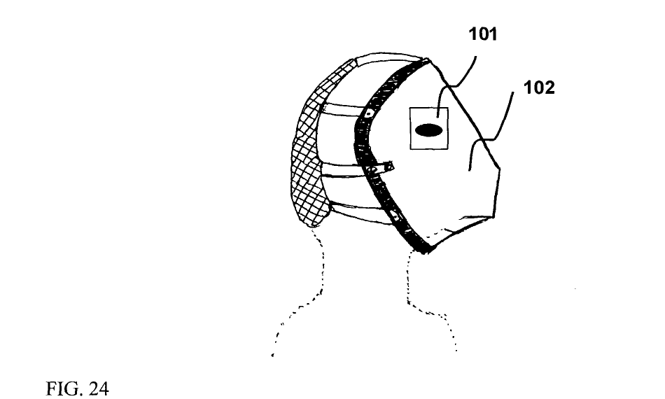

FIG. 7 shows the preferred embodiment in which the navigator or other user uses a lightweight head-worn display device (which may include headphones). See FIG. 24 for a conceptual drawing of the EFR preferred embodiment in which a customized SCBA 102 shows the monocular HMD eyepiece 101 visible from the outside of the mask. Furthermore, because first responders are associated with a number of different professions, the customized facemask could be part of a firefighter's SCBA (Self-Contained Breathing Apparatus), part of a HAZMAT or radiation suit, or part of a hard hat which has been customized accordingly.

There are many varieties of HMDs which would be acceptable for this invention, including see-through and non-see-through types. In the preferred embodiment, a see-through monocular HMD is used. Utilization of a see-through type of HMD allows the view of the real world to be obtained directly by the wearer of the device.

In a second preferred embodiment, a non-see-through HMD would be used as the display device. In this case, the images of the real world (as captured via video camera) are mixed with the computer-generated images by using additional hardware and software components known to those skilled in the art.

Handheld Displays

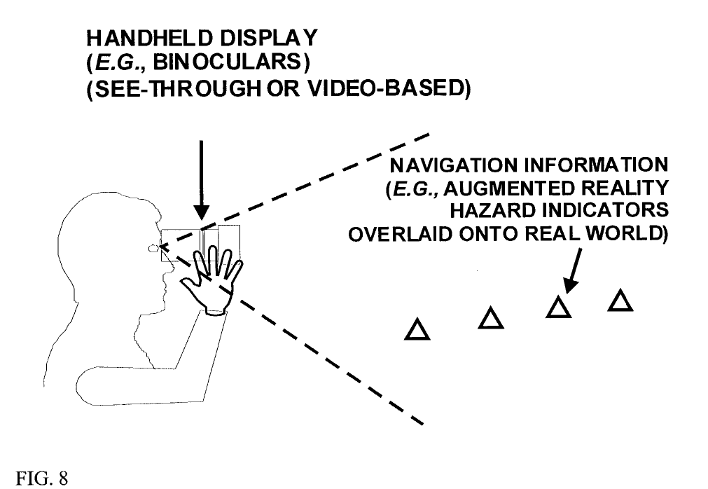

In a second embodiment, the navigator or other user uses a handheld display as shown in FIG. 8. The handheld display can be similar to binoculars or to a flat panel type of display and can be either see-through or non-see-through. In the see-through embodiment of this method, the user looks through the “see-through” portion (a transparent or semitransparent surface) of the hand-held display device (which can be a monocular or binocular type of device) and views the computer-generated elements projected onto the view of the real surroundings. Similar to the embodiment of this method which utilizes a non-see-though HMD, if the user is using a non-see-though hand-held display device, the images of the real world (as captured via video camera) are mixed with the computer-generated images by using additional hardware and software components.

An advantage of the handheld device for the navigation embodiment is that such a display would allow zooming in on distant objects. In a video-based mode, a control on the display would control zoom of the camera used to provide the live real-world image. In an optical see-through AR system, an optical adjustment would be instrumented to allow the computer to determine the correct field of view for the overlay imagery.

The hand-held embodiment of the invention may also be integrated into other devices (which would require some level of customization) commonly used by first responders, such as Thermal Imagers, Navy Firefighter's Thermal Imagers (NFTI), or Geiger counters.

Heads-Up Displays (non-HMD)

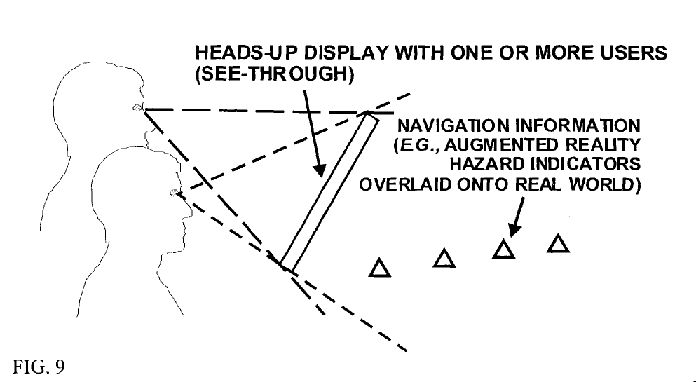

A third, see-through, display hardware embodiment which consists of a non-HMD heads-up display (in which the user's head usually remains in an upright position while using the display unit) is shown in FIG. 9. This type of display is particularly conducive to a navigation embodiment of the invention in which multiple users can view the AR navigation information. The users may either have individual, separate head-worn displays, or a single display may be mounted onto a window in a ship's cockpit area and shared by one or more of the ship's navigators.

Other Display Devices

The display device could be a “heads-down” type of display, similar to a computer monitor, used within a vehicle (i.e., mounted in the vehicle's interior). The display device could also be used within an aircraft (i.e., mounted on the control panel or other location within a cockpit) and would, for example, allow a pilot or other navigator to “visualize” vortex data and unseen runway hazards (possibly due to poor visibility because of fog or other weather issues). Furthermore, any stationary computer monitor, display devices which are moveable yet not small enough to be considered “handheld,” and display devices which are not specifically handheld but are otherwise carried or worn by the user, could serve as a display unit for this method.

Acquisition of a View of the Real World

In the preferred embodiment of this inventive method, the view of the real world (which may be moving or static) is inherently present through a see-though HMD. Likewise, if the user uses a handheld, see-through display device, the view of the real world is inherently present when the user looks through the see-through portion of the device. The “see-through” nature of the display device allows the user to “capture” the view of the real world simply by looking through an appropriate part of the equipment. No mixing of real world imagery and computer-generated graphical elements is required—the computer-generated imagery is projected directly over the user's view of the real world as seen through a semi-transparent display. This optical-based embodiment minimizes necessary system components by reducing the need for additional hardware and software used to capture images of the real world and to blend the captured real world images with the computer-generated graphical elements.

Embodiments of this method using non-see through display units obtain an image of the real world with a video camera connected to a computer via a video cable. In this case, the video camera may be mounted onto the display unit. Using a commercial-off-the-shelf (COTS) mixing device, the image of the real world is mixed with the computer-generated graphical elements and then presented to the user.

A video-based embodiment of this method could use a motorized camera mount for tracking position and orientation of the camera. System components would include a COTS motorized camera, a COTS video mixing device, and software developed for the purpose of telling the computer the position and orientation of the camera mount. This information is used to facilitate accurate placement of the computer-generated graphical elements within the user's composite view.

External tracking devices can also be used in the video-based embodiment. For example, a GPS tracking system, an optical tracking system, or another type of tracking system would provide the position and orientation of the camera. Furthermore, a camera could be used that is located at a pre-surveyed position, where the orientation of the camera is well known, and where the camera does not move.

It may be desirable to modify the images of reality if the method is using a video-based embodiment. For instance, in situations where a thermal sort of view of reality is desired, the image of the real world can be modified to appear in a manner similar to a thermal view by reversing the video, removing all color information (so that only brightness remains as grayscale), and, optionally, coloring the captured image green.

Creation of Computer-Generated Graphical Elements

Data collected from multiple sources is used in creation of the computer-generated graphical elements. The computer-generated graphical elements can represent any object (seen and unseen, real and unreal) and can take multiple forms, including but not limited to wireframe or solid graphics, moving or static objects, patterned displays, colored displays, text, and icons. Broadly, the data may be obtained from pre-existing sources such as charts or blueprints, real-time sources such as radar, or by the user at a time concurrent with his/her use of the invention.

The inventive method utilizes representations which can appear as many different hazards. The computer-generated representations can be classified into two categories: reproductions and indicators. Reproductions are computer-generated replicas of an element, seen or unseen, which would pose a danger to a user if it were actually present. Reproductions also visually and audibly mimic actions of the real objects (e.g., a computer-generated representation of water might turn to steam and emit a hissing sound when coming into contact with a computer-generated representation of fire). Representations which would be categorized as reproductions can be used to indicate appearance, location and/or actions of many visible objects, including, but not limited to, fog, sand bars, bridge pylons, fire, water, smoke, heat, radiation, chemical spills (including display of different colors for different chemicals), and poison gas. Furthermore, reproductions can be used to simulate the appearance, location and actions of unreal objects and to make invisible hazards (as opposed to hazards which are hidden) visible. This is useful for many applications, such as training scenarios where actual exposure to a situation or a hazard is too dangerous, or when a substance, such as radiation, is hazardous and invisible or otherwise unseen. Additional applications include recreations of actual past events involving potentially hazardous phenomena for forensic or other investigative purposes. Representations which are reproductions of normally invisible objects maintain the properties of the object as if the object were visible—invisible gas has the same movement properties as visible gas and will act accordingly in this method. Reproductions which make normally invisible objects visible include, but are not limited to, completely submersed sandbars, reefs, and sunken objects; steam; heat; radiation; colorless poison gas; and certain biological agents. The second type of representation is an indicator. Indicators provide information to the user, including, but not limited to, indications of object locations (but not appearance), warnings, instructions, or communications. Indicators may be represented in the form of text messages and icons. Examples of indicator information may include procedures for dealing with a difficult docking situation, textual information that further describes radar information, procedures for clean-up of hazardous material, location of a member of a fellow EFR team member, or a message noting trainee (simulated) death by fire, electrocution, or other hazard after using improper procedures (useful for training purposes).

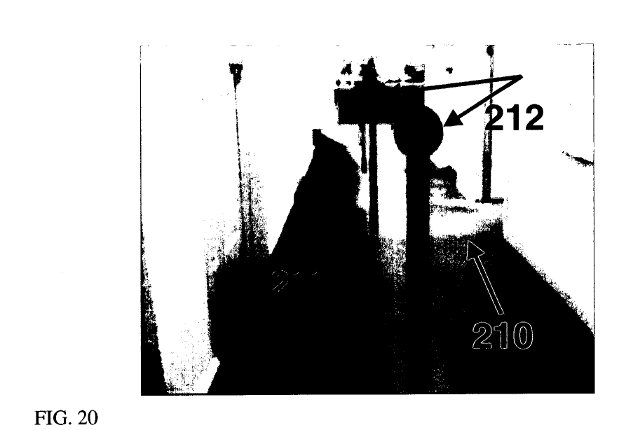

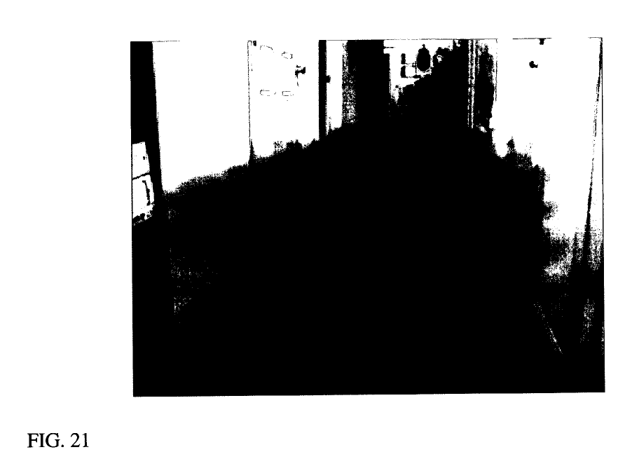

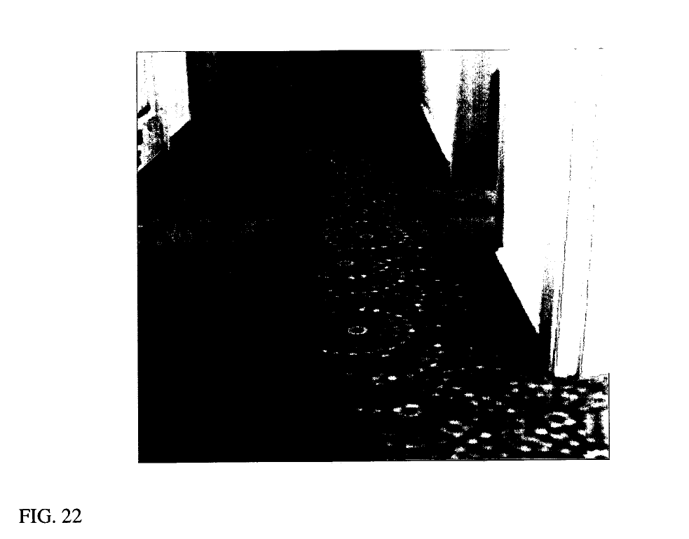

The inventive method utilizes representations (which may be either reproductions or indicators) which can appear as many different objects or hazards. For example, hazards and the corresponding representations may be stationary three-dimensional objects, such as buoys, signs or fences. These representations can be used to display a safe path around potentially hazardous phenomena to the user. They could also be dynamic (moving) objects, such as fog or unknown liquids or gasses that appear to be bubbling or flowing out of the ground. Some real objects/hazards blink (such as a warning indicator which flashes and moves); twinkle (such as a moving spill which has a metallic component); or explode (such as bombs, landmines and exploding gasses and fuels); the computer-generated representation of those hazards would behave in the same manner. In FIG. 20, an example of a display resulting from the inventive method is presented, indicating a safe path to follow 210 in order to avoid coming in contact with a nuclear/radiological event 211 or other kind of hazard 211 by using computer-generated poles 212 to demarcate the safe area 210 from the dangerous areas 211. FIG. 21 shows a possible display to a user where a gas/fumes or other substance is present, perhaps due to a terrorist attack. FIG. 22 is an example of a display which a user may see in a hazmat training situation, with the green overlay indicating the region where hazardous materials are. The center of the displays is more intensely colored than the edges where the display is semi-transparent and fuzzy. This is a key feature of the inventive method whereby use of color, semi-transparency, and fuzziness are an indication of the level of potential danger posed by the hazard being displayed, thereby increasing situational awareness. Additional displays not shown here would include a chemical/radiation leak coming out of the ground and visually fading to its edge, while simultaneously showing bubbles which could represent the action of bubbling (from a chemical/biological danger), foaming (from a chemical/biological danger), or sparkling (from a radioactive danger).

Movement of the representation of the object/hazard may be done with animated textures mapped onto three-dimensional objects. For example, movement of a “slime” type of substance over a three-dimensional surface could be accomplished by animating to show perceived outward motion from the center of the surface. This is done by smoothly changing the texture coordinates in OpenGL, and the result is smooth motion of a texture mapped surface.

The representations describing objects/hazards and other information may be placed in the appropriate location by several methods. In one method, the user can enter information (such as significant object positions and types) and representations into his/her computer upon encountering the objects/hazards (including victims) while traversing the space, and can enter such information to a database either stored on the computer or shared with others on the scene. A second, related method would be one where information has already been entered into a pre-existing, shared database, and the system will display representations by retrieving information from this database. A third method could obtain input data from sensors such as a video cameras, thermometers, motion sensors, or other instrumentation placed by users or otherwise pre-installed in the space.

The rendered representations can also be displayed to the user without a view of the real world. This would allow users to become familiar with the characteristics of a particular object/hazard without the distraction of the real world in the background. This kind of view is known as virtual reality (VR).

Navigation Displays

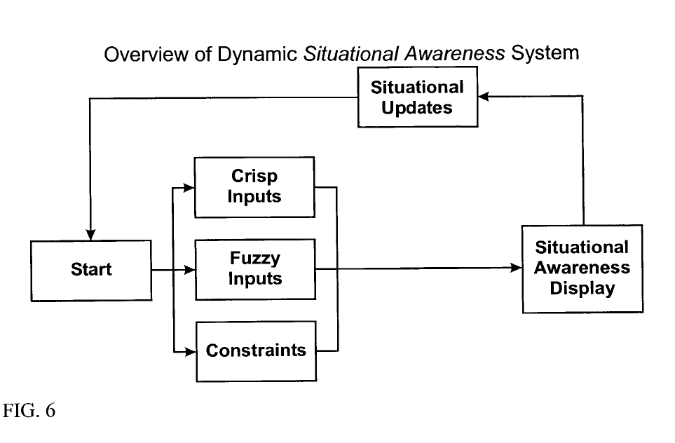

The preferred navigation embodiment for the method described has direct applications to waterway navigation. Current navigation technologies such as digital navigation charts and radar play an important role in this embodiment. For example, digital navigation charts (in both raster and vector formats) provide regularly updated information on water depths, coastal features, and potential hazards to a ship. Digital chart data may be translated into a format useful for AR, such as a bitmap, a polygonal model, or a combination of the two (e.g., texture-mapped polygons). Radar information is combined with digital charts in existing systems, and an AR navigation aid can also incorporate a radar display capability thus allowing the navigator to “see” radar-detected hazards such as the locations of other ships and unmapped coastal features. Additionally, navigation aids such as virtual buoys can be incorporated into an AR display (see FIGS. 6-8). The virtual buoys can represent either buoys actually present but obscured from sight due to a low visibility situation or normally-present buoys which are no longer existent or no longer located at their normal location. Furthermore, the preferred embodiment can utilize 3-D sound to enhance an AR environment with simulated real-world sounds and spatial audio cues, such as audio signals from real or virtual buoys, or an audio “alert” to serve as a warning.

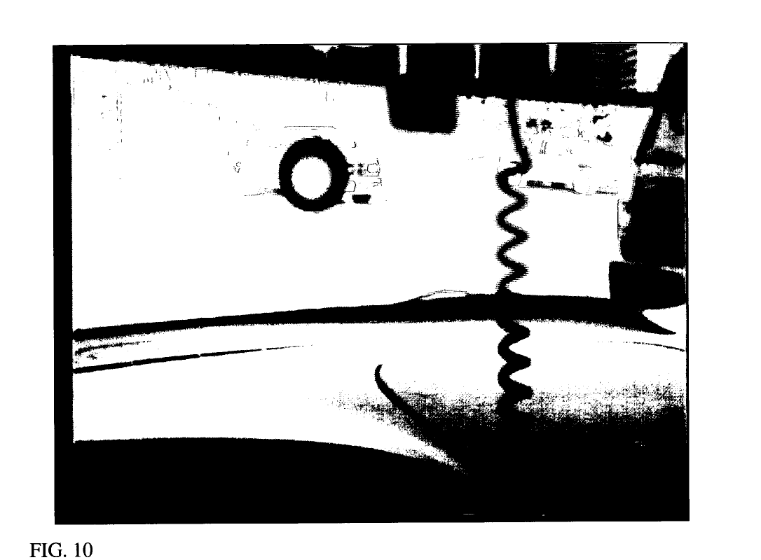

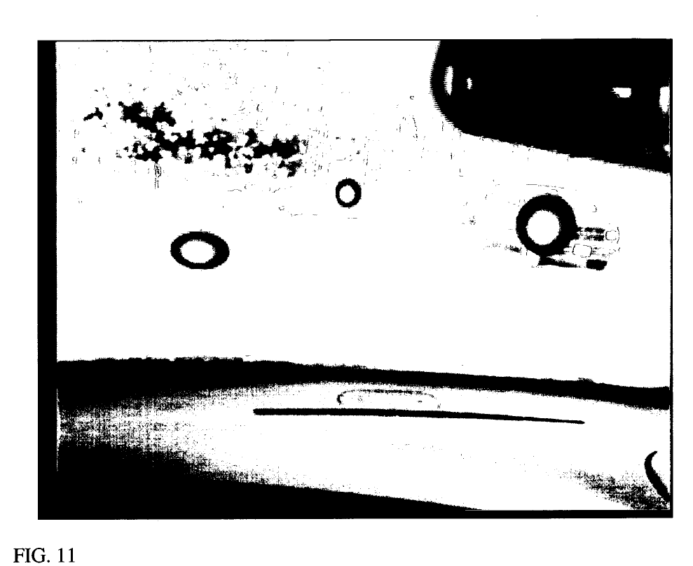

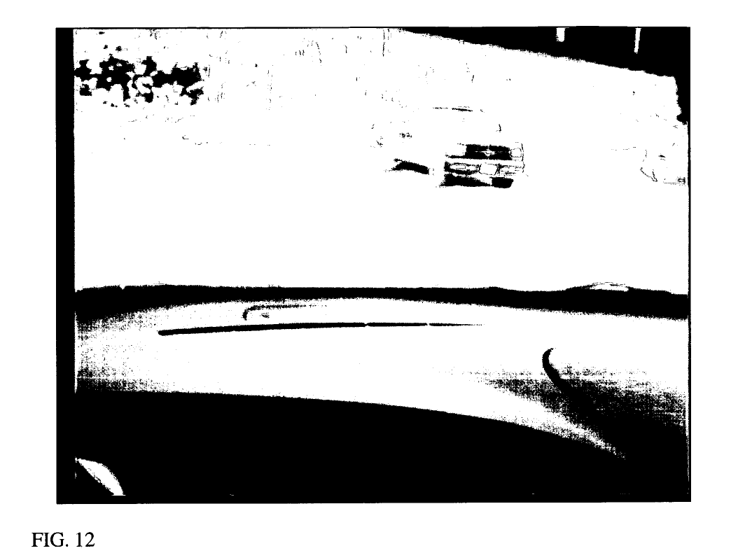

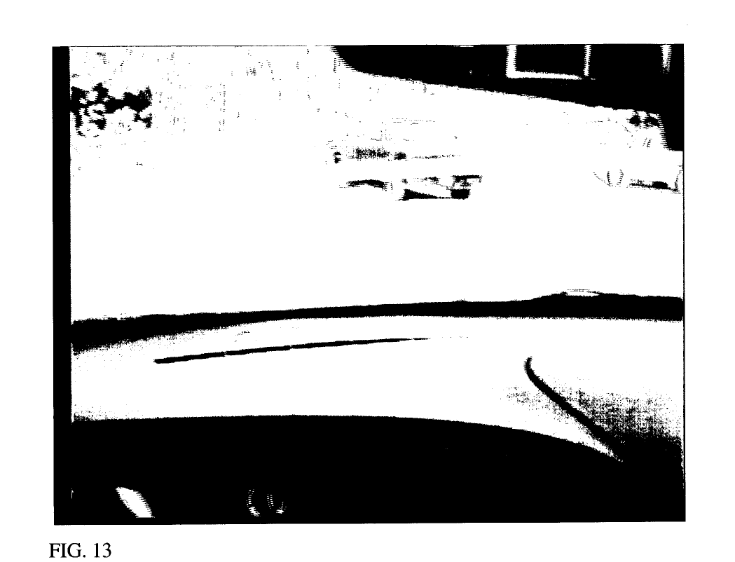

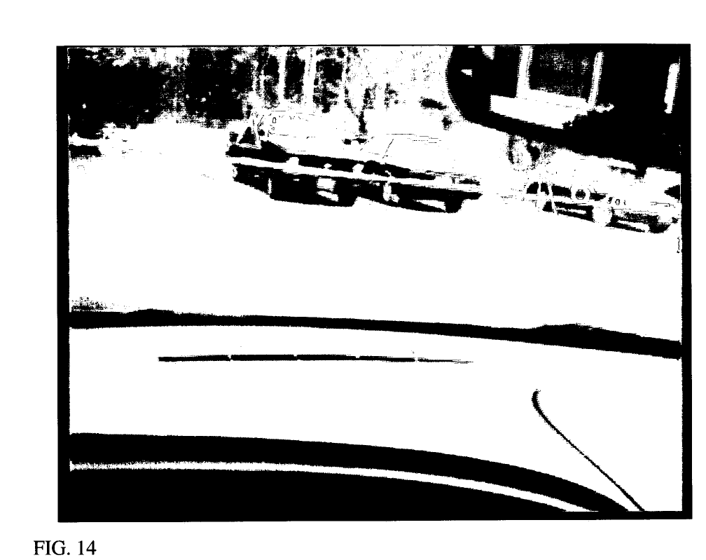

A challenge in the design of an AR navigation system is determining the best way to present relevant information to the navigator, while minimizing cognitive load. Current ship navigation systems present digital chart and radar data on a “heads-down” computer screen located on the bridge of a ship. These systems require navigators to take their eyes away from the outside world to ascertain their location and the relative positions of hazards. An AR overlay, which may appear as one or more solid or opaque two-dimensional Gaussian objects (as in FIGS. 10 and 11), wireframe, or semi-transparent (fuzzy) graphic (as in FIG. 12), can be used to superimpose only pertinent information directly on a navigator's view when and where it is needed. Furthermore, the display of the two-dimensional Gaussian objects may be either symmetrical or non-symmetrical (also shown in FIGS. 10 and 11). The AR overlay may also contain a combination of graphics and alphanumeric characters, as shown in FIGS. 13 and 14. Also shown in FIGS. 10 through 14 is the use of color and bands of color to illustrate levels of probability, where the yellow areas indicate a higher probability and red a lower level of probability. Alternate colors can be used to suggest information consonance or dissonance as appropriate. It should also be noted that in FIGS. 10 through 14, the outer edges of the computer-generated graphical elements are actually fuzzy rather than crisp (limitations of display and image capture technology may make it appear otherwise).

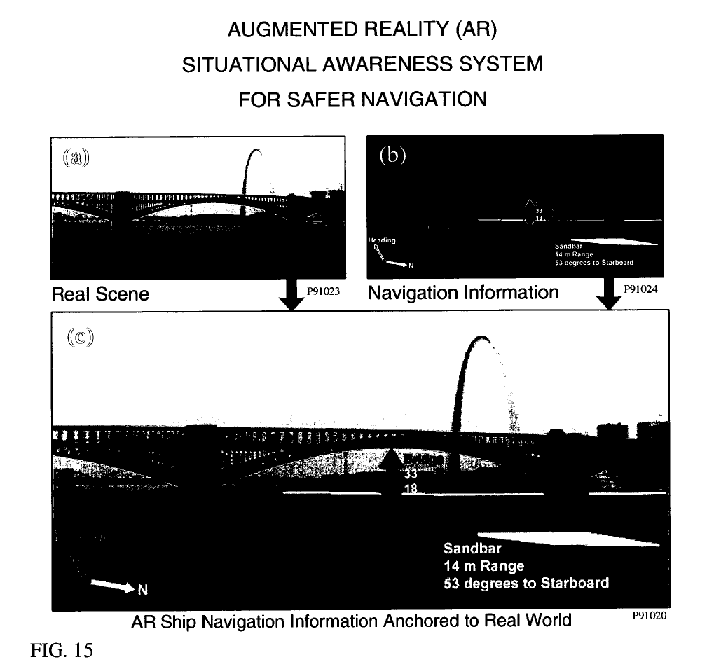

FIG. 15 shows the components of an AR overlay which will dynamically superimpose relevant information onto a navigator's view of the real world, leading to safer and easier waterway navigation. Computer-generated navigation information will illuminate important features (e.g., bridge pylons, sandbars, and coastlines) for better navigation on waterways such as the Mississippi River. The inventive method will display directly to the navigator real-time information (indicated by white text), such as a ship's heading and range to potential hazards.

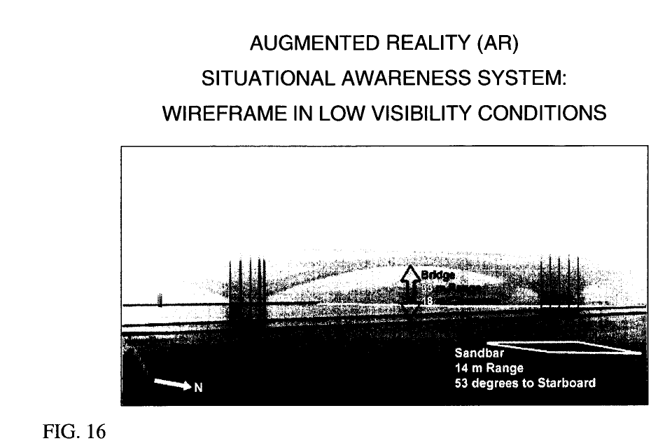

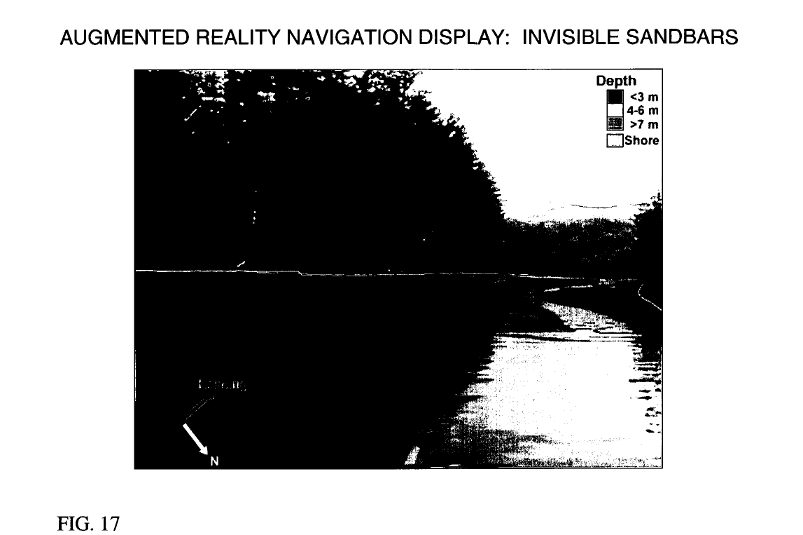

FIG. 16 shows a diagram of a graphic for overlay on a navigator's view. In this embodiment, the overlay includes wireframe representations of bridge pylons and a sandbar. Alternatively, the overlay could also display the bridge pylons and sandbar as solid graphics (not shown here) to more realistically portray real world elements. The ship's current heading is indicated with arrows, and distance from hazards is drawn as text anchored to those hazards. FIG. 17 shows a display embodiment in which color-coded water depths are overlaid on a navigator's view in order to display unseen subsurface hazards such as sandbars. The safest path can easily be seen in green, even if buoys are not present. In this embodiment, the color fields indicating depth are semi-transparent. The depth information can come from pre-existing charts or from a depth finder. The key provided with the computer-generated graphic overlay allows the navigator to infer a safe or preferred route based on the water depth. Whether or not buoys are present, it may be easier for the mariner to navigate among shallow depths with this type of AR display—all without having to look down at a separate display of navigation information.

A minimally intrusive overlay is generally considered to have the greatest utility to the navigator. To minimize cognitive load, there are several steps to make the display user-friendly: (a) organizing information from 2-D navigation charts into a 3-D AR environment; (b) minimizing display clutter while still providing critical information; (c) using color schemes as a way of assisting navigators in prioritizing the information on the display; (d) selecting wireframe vs. semi-transparent (fuzzy) vs. solid display of navigation information; (e) dynamically updating information; (f) displaying the integrity of (or confidence in) data to account for uncertainty in the locations of ever-changing hazards such as sandbars; (g) providing a “predictor display” that tells a navigator where his/her ship will be in the near future and alerting the navigator as to potential collisions). A combination of these elements leads to a display which is intuitive to the navigator and allows him/her to perform navigational duties rather than focus on how to use the invention.

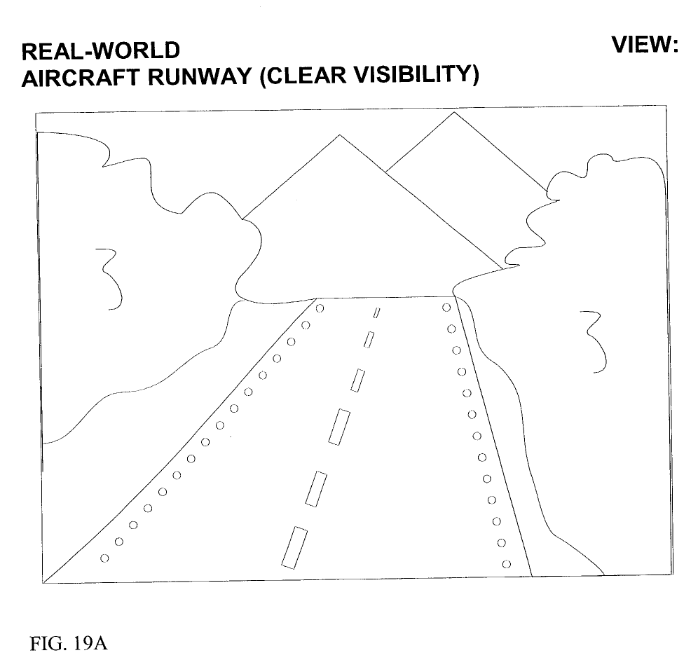

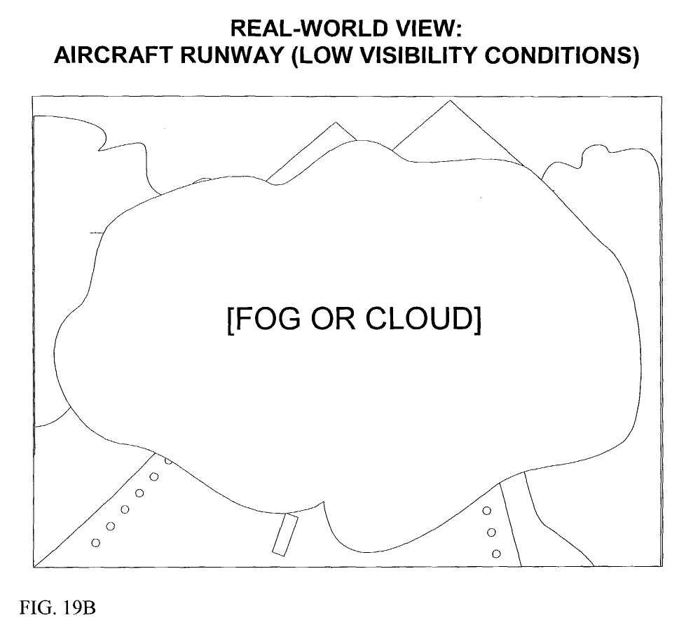

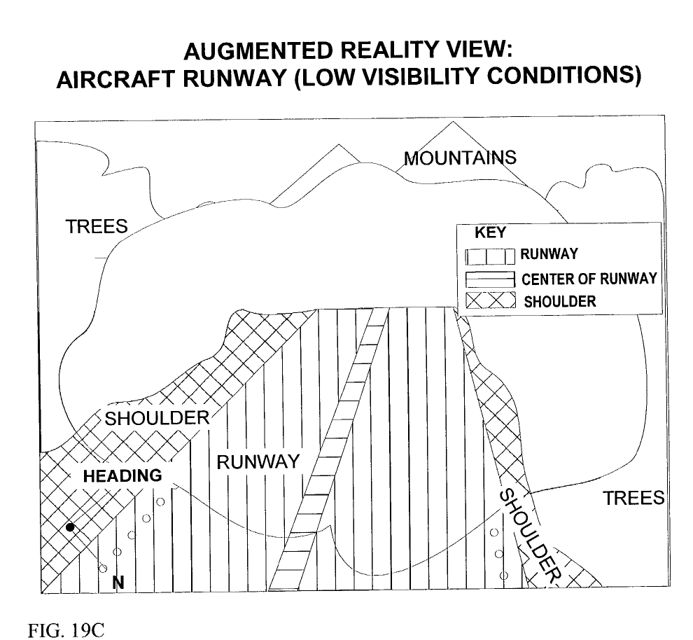

Specifically, in the preferred embodiment a navigator would use an AR display which contains a minimal amount of clutter consisting of a 3D display of pertinent navigation information, including wireframe, semitransparent/transparent, or solid displays. Levels of uncertainty in the integrity and confidence of the data are represented through attributes including color and transparency (including colored regions with “fuzzy” edges to indicate that the exact value for that area of the display is not known, but rather a range of values is displayed, usually darkest at the center and fading outward—this methodology can be used to indicate to the user the level of expected error in locating an object such as a buoy, and a virtual buoy could be drawn bigger (with perhaps a fuzzy border) to convey the expected region that the buoy should be located rather than the precise location of the buoy), textual overlay, and/or combined color and color key displays. Additional use of color, (which is displayed in FIG. 19C as a patterned overlay) provides for representations of water depth and safe navigation paths, levels of danger, and importance of display items. The navigator uses various display attributes, which can also include 3-D sound, to assess the information and to complete a safe passage.

EFR Command, Control and Safety Displays

An EFR preferred embodiment of the inventive method utilizes computer-generated three-dimensional graphical elements to represent actual and fictional potentially hazardous phenomena. The computer-generated imagery is combined with the user's view of the real world such that the user visualizes potentially hazardous phenomena, seen, hidden and/or invisible, real and unreal, within his/her immediate surroundings. Furthermore, not only is the potentially hazardous visualized in a manner which is harmless to the user, the visualization of the potentially hazardous phenomena provides the user with information regarding location, size, and shape of the hazard; location of safe regions (such as a path through a region that has been successfully decontaminated of a biological or chemical agent) in the immediate vicinity of the potentially hazardous phenomena; as well as its severity. The representation of the potentially hazardous phenomena can look and sound like the actual hazard itself (i.e., a different representation for each hazard type). Furthermore, the representation can make hidden or otherwise unseen potentially hazardous phenomena visible to the user. The representation can also be a textual message, which would provide information to the user, overlaid onto a view of the real background, in conjunction with the other, non-textual graphical elements, if desired.

As with the navigation embodiment of the inventive method, the representations can also serve as indications of the intensity and size of a hazard. Properties such as fuzziness, fading, transparency, and blending can be used within a computer-generated graphical element to represent intensity and spatial extent and edges of hazard(s). For example, a representation of a potentially hazardous material spill could show darker colors at the most heavily saturated point of the spill and fade to lighter hues and greater transparency at the edges, indicating less severity at location of the spill at the edges. Furthermore, the edges of the representations may be either blurred or crisp to indicate whether or not the potentially hazardous phenomena stops suddenly or gradually.

Audio warning components, appropriate to the hazard(s) being represented, also can be used in this embodiment. Warning sounds can be presented to the user along with the mixed view of rendered graphical elements with reality. Those sounds may have features that include, but are not limited to, chirping, intermittent, steady frequency, modulated frequency, and/or changing frequency.

In the preferred EFR embodiment (FIG. 23), an indicator generated by the incident commander is received by the EFR; it is rendered by the EFR's computer, and displayed as an image in the EFR's forward view via a Head Mounted Display (HMD) 45. The indicators may be text messages, icons, or arrows as explained below.

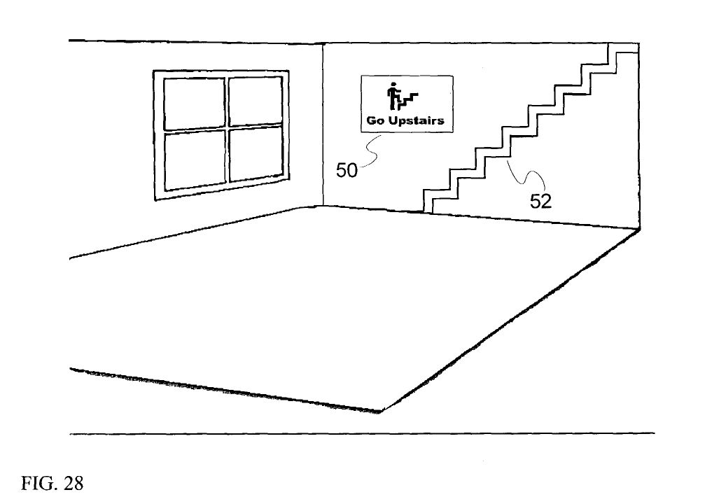

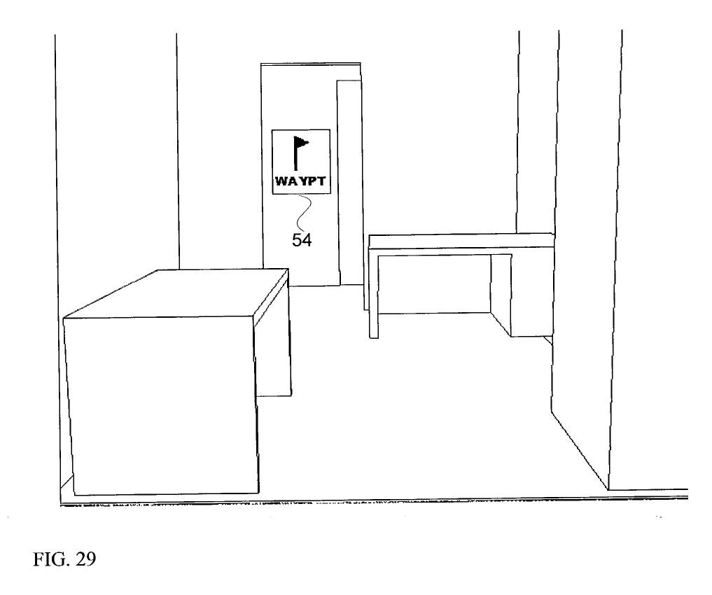

If the data is directional data instructing the EFR where to proceed, the data is rendered and displayed as arrows or as markers or other appropriate icons. FIG. 29 shows a possible mixed text and icon display 50 that conveys the message to the EFR to proceed up the stairs 52. FIG. 28 shows an example of mixed text and icon display 54 of a path waypoint.

Text messages are rendered and displayed as text, and could contain warning data making the EFR aware of dangers of which he/she is presently unaware.

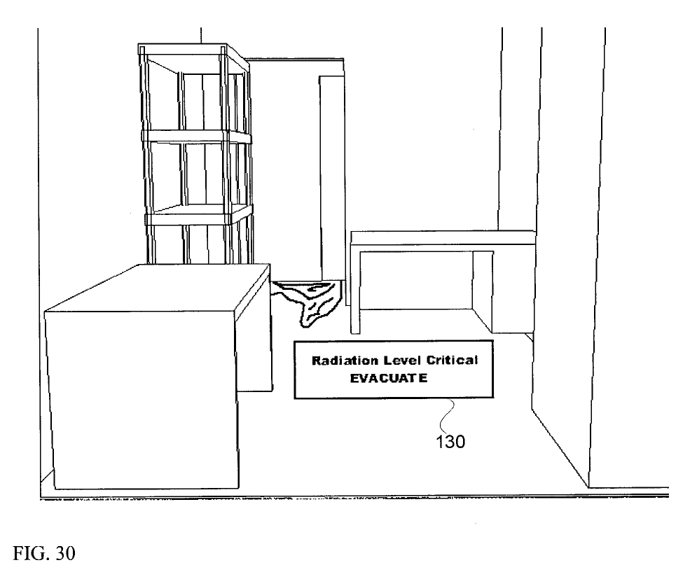

Icons representative of a variety of hazards can be rendered and displayed to the EFR, provided the type and location of the hazard is known. Specifically, different icons could be used for such dangers as a fire, a bomb, a radiation leak, or a chemical spill. See FIG. 30 for a text message 130 relating to a leak of a radioactive substance.

The message may contain data specific to the location and environment in which the incident is taking place. A key code, for example, could be sent to an EFR who is trying to safely traverse a secure installation. Temperature at the EFR's location inside an incident space could be displayed to the EFR provided a sensor is available to measure that temperature. Additionally, temperatures at other locations within the structure could be displayed to the EFR, provided sensors are installed at other locations within the structure.

If the EFR is trying to rescue a victim downed or trapped in a building, a message could be sent from the incident commander to the EFR to assist in handling potential injuries, such as First Aid procedures to aid a victim with a known specific medical condition.

The layout of the incident space can also be displayed to the EFR as a wireframe rendering (see FIG. 31). This is particularly useful in low visibility situations. The geometric model used for this wireframe rendering can be generated in several ways. The model can be created before the incident; the dimensions of the incident space are entered into a computer and the resulting model of the space would be selected by the incident commander and transmitted to the EFR. The model is received and rendered by the EFR's computer to be a wireframe representation of the EFR's surroundings. The model could also be generated at the time of the incident. Technology exists which can use stereoscopic images of a space to construct a 3D-model based on that data. This commercial-off-the-shelf (COTS) equipment could be worn or carried by the EFR while traversing the incident space. The equipment used to generate the 3D model could also be mounted onto a tripod or other stationary mount. This equipment could use either wireless or wired connections. If the generated model is sent to the incident commander's computer, the incident commander's computer can serve as a central repository for data relevant to the incident. In this case, the model generated at the incident scene can be relayed to other EFRs at the scene. Furthermore, if multiple model generators are being used, the results of the various modelers could be combined to create a growing model which could be shared by all users.

Interaction with Displays

Display configuration issues can be dealt with by writing software to filter out information (such as extraneous lighting at a dock), leaving only what is most pertinent, or by giving a navigator control over his/her view augmentation. Use of (a) button presses on a handheld device to enable or disable aspects of the display and call up additional information on objects in the field of view, (b) voice recognition to allow hands-free interaction with information, (c) a touch screen, and (d) a mouse, are means of interaction. An input device also provides the ability to mark new object/hazards that are discovered by the user. For example, a navigator may encounter an unexpected obstacle (such as a recently fallen tree) and choose to add that to the display.

The inventive method provides the user with interactions and experiences with realistic-behaving three dimensional computer-generated invisible or otherwise unseen potentially hazardous phenomena (as well as with visible potentially hazardous phenomena) in actual locations where those phenomena may occur, can occur, could occur and do occur. For example, while using the system, the user may experience realistic loss of visibility due to the hazard. The user can also perform appropriate “clean up” procedures and “see” the effect accordingly. Site contamination issues can be minimized as users learn the correct and incorrect methods for navigating in, through, and around an incident area.

Combining Computer-Generated Graphical Elements with the View of the Real World and Presenting it to the User

In the preferred optical-based embodiments, a see-through HMD is used. This allows the view of the real world to be directly visible to the user through the use of partial mirrors. The rendered computer-generated graphical elements are projected into this device, where they are superimposed onto the view of the real world seen by the user. Once the computer renders the representation, it is combined with the real world image. The combined view is created automatically through the use of the partial mirrors used in the see-through display device with no additional equipment required.

Video-based (non-see-through) embodiments utilizing non-see through display units require additional hardware and software for mixing the captured image of the real world with the representation of the hazard. For example, an image of the real world acquired from a camera may be combined with computer generated images using a hardware mixer. The combined view in those embodiments is presented to the user on a non-see-through HMD or other non-see-through display device.

Regardless of the method used for combining the images, the result is an augmented view of reality for the EFR for use in both training and actual operations.

Use in Training Scenarios and in Operations.

The inventive method for utilizing computer-generated three-dimensional representations to visualize hazards has many possible applications. Broadly, the representations can be used extensively for both training and operations scenarios.

Navigation

The invention is readily applicable to operational use in waterway, land, and aircraft navigation. Furthermore, each of the navigation embodiments described has applications to training waterway, land, and aircraft navigators right on the actual platform those navigators will use in the real environment in which they will be traveling. To train these personnel, the users wear the display device, and the system displays virtual hazards to the user during a training exercise. Such exercises would be appropriate to the platform for which training is occurring, such as but not limited to low water, fog, missing buoys, other boats/cars/aircraft, and tall buildings.

EFR Command, Control and Safety

EFR embodiments of the invention can be used in actual operations during emergency incidents as described above. Operational use of this method would use representations of hazards where dangerous invisible or otherwise unseen objects or events are occurring, or could occur, (e.g., computer-generated visible gas being placed in the area where real invisible gas is expected to be located). Applications include generation of computer-generated elements while conducting operations in dangerous and emergency situations.

The invention also has a great deal of potential as a training tool. Many training situations are impractical or inconvenient to reproduce in the real world (e.g., flooding in an office), unsafe to reproduce in the real world (e.g., fires aboard a ship), or impossible to produce in the real world (e.g., “see” otherwise invisible radioactivity, or “smell” otherwise odorless fumes). Computer-generated representations of these hazards will allow users to learn correct procedures for alleviating the incident at hand, yet maintain the highest level of trainee and instructor safety. Primary applications are in the training arena where response to potential future dangerous or emergencies must be rehearsed. Finally, training with this method also allows for intuitive use of the method in actual operations, where lives and property can be saved with its use.

System Summary

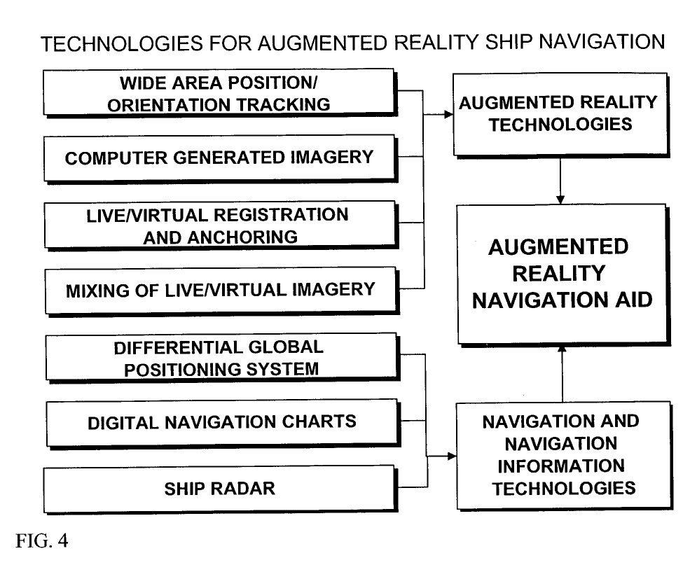

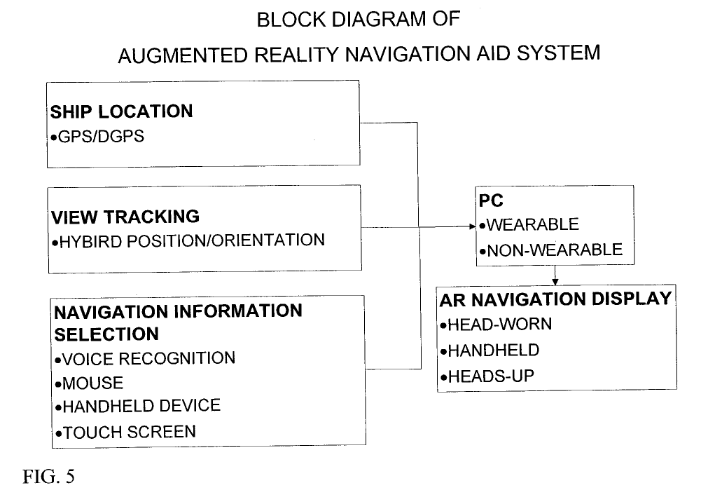

The technologies that contribute to this invention are summarized in FIG. 4 and FIG. 5. FIG. 4 provides a general overview of the technologies in relation to the invention. FIG. 5 shows a hardware-oriented diagram of the technologies required for the invention. FIG. 6 is an overview of the augmented reality situational awareness system, including registration of dynamically changing information utilizing fuzzy logic analysis technologies, an update and optimization loop, and user interactivity to achieve information superiority for the user.

Other Embodiments

Navigation—Land

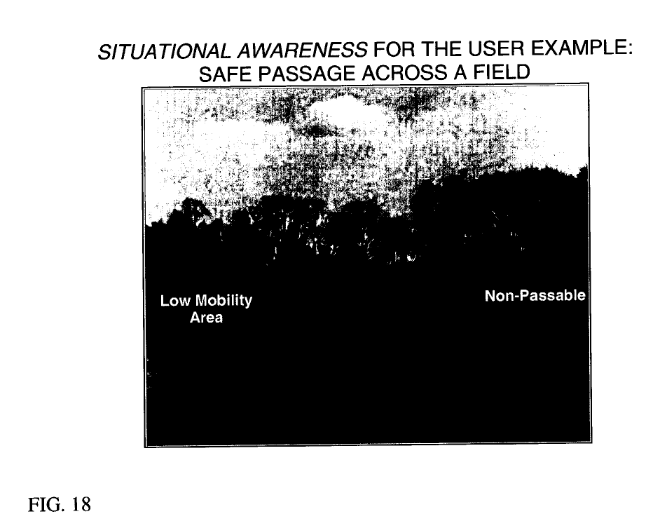

Another embodiment of an invention such as the one described here would be for land navigation. As shown in FIG. 18, dangerous areas of travel and/or a preferred route may be overlaid on a driver's field of view. In this figure, information on passive threats to the user's safe passage across a field is overlaid directly on the user's view. The safest path can easily be seen in green—all without having to look down at a separate display of information, terrain maps, or reports. The travel hazard indicators appear to the user as if they are anchored to the real world—exactly as if he/she could actually see the real hazards.

Navigation—Air

Air navigation is another potential embodiment, where the invention will provide information to help navigators approach runways during low-visibility aircraft landings and in aircraft terrain avoidance. See FIG. 12.

Similar technologies to those described for waterway navigation would be employed to implement systems for either a land or air navigation application. In FIG. 4 all of the technologies, with the exception of the Ship Radar block (which can be replaced with a “Land Radar” or “Aircraft Radar” block) are applicable to land or air embodiments.

1. A method of using an augmented reality navigation system on a moving transportation platform selected from the group of transportation platforms consisting of a water transportation device such as a ship, a land transportation device such as a motor vehicle, and an air transportation device such as an airplane, to prioritize and assess navigation data, comprising:
obtaining navigation information relating to the transportation platform;
providing a display unit that provides the user with a view of the real world;
creating a virtual imagery graphical overlay of relevant navigation information corresponding to the user's field of view, the graphical overlay created using graphics technology that reduces cognitive load, including using color schemes as a way of assisting the user in prioritizing the information on the display unit, and presenting data using a predictor display which displays to the user where the transportation platform will be in the near future; and
displaying the graphical overlay in the display unit, so that the user sees an augmented reality view comprising both the real world and the graphical overlay.

2. The method of claim 1 in which the navigation information includes digital navigation charts.

3. The method of claim 1 in which the navigation information includes information from a radar system.

4. The method of claim 1 in which the navigation information includes the platform's distance from hazards.

5. The method of claim 1 in which the navigation information includes water depth.

6. The method of claim 1 in which navigation information is displayed as a semi-transparent or fuzzy (soft-bordered) graphic.

7. The method of claim 1 applied to waterway navigation.

8. The method of claim 1 in which the graphics technology that reduces cognitive load comprises displaying 2-D navigation chart information in a 3-D Augmented Reality environment.

9. The method of claim 1 in which the virtual imagery graphical overlay includes the superposition of virtual buoys onto the field of view of the user to indicate the location of real buoys that are obscured from sight.

10. The method of claim 1 in which the virtual imagery graphical overlay includes the superposition of virtual buoys onto the field of view of the user to provide the functionality of real buoys, when real buoys are not present.

11. The method of claim 1 in which a user is trained in performing navigational duties by showing virtual hazards to the user while in a real navigational platform in a real environment.

12. The method of claim 1 in which color is used to represent water depth.

13. The method of claim 1 in which the predictor display alerts the navigator to potential collisions.

14. A method of augmented reality visualization of hazards, comprising:
providing a display unit for the user;
providing motion tracking hardware;
using the motion tracking hardware to determine the location and direction of the viewpoint to which the computer-generated three-dimensional graphical elements are being rendered; providing an image or view of the real world;
using a computer to generate three-dimensional graphical elements as representations of hazards;
rendering the computer-generated graphical elements to correspond to the user's viewpoint;
creating for the user a mixed view comprised of an actual view of the real world as it appears in front of the user, where graphical elements can be placed anywhere in the real world and remain anchored to that place in the real world regardless of the direction in which the user is looking, wherein the rendered graphical elements are superimposed on the actual view, to accomplish an augmented reality view of representations of hazards in the real world; and
presenting the augmented reality view, via the display unit, to the user.

15. The method of claim 14 in which the representations are objects that appear to be emanating out of the ground.

16. The method of claim 14 in which the rendered computer-generated three-dimensional graphical elements are representations displaying an image property selected from the group of properties consisting of fuzziness, fading, transparency, and blending, to represent the intensity, spatial extent, and edges of at least one hazard.

17. The method of claim 14 in which the display device is integrated into a hand held device selected from the group of devices consisting of a Thermal Imager, a Navy Firefighter's Thermal Imager (NFTI), and a Geiger counter.

18. The method of claim 14 in which a graphical element is used to represent harmful hazards that are located in an area, the harmful hazard selected from the group of hazards consisting of a fire, a bomb, a radiation leak, a chemical spill, and poison gas.

19. The method of claim 14 in which a user can see a display of the paths of other users taken through the space.

20. A method of accomplishing an augmented reality hazard visualization system for a user, comprising:
providing a display unit;
providing the user with a hazardous phenomena cleanup device;
providing motion tracking hardware, and attaching it to both the head-worn display unit and the hazardous phenomena cleanup device;
using the motion tracking hardware that is attached to the head worn unit and to determine the location and direction of the viewpoint of the head-worn display unit;
using the motion tracking hardware that is attached to the hazardous phenomena cleanup device to determine the location and direction of the aimpoint of the hazardous phenomena cleanup device;
determining the operating state of the hazardous phenomena cleanup device;
using a computer to generate graphical representations comprising simulated potentially hazardous phenomena, and simulated application of hazardous phenomena cleanup agent, showing the cleanup agent itself emanating directly from the hazardous phenomena cleanup device, and showing the interaction of the cleanup agent with the hazardous phenomena;
rendering the generated graphical elements to correspond to the user's viewpoint; and
creating for the user a mixed view comprised of an actual view of the real world as it appears in front of the user, where graphical elements can be placed any place in the real world and remain anchored to that place in the real world regardless of the direction in which the user is looking, wherein the rendered graphical elements are superimposed on the actual view, to accomplish an augmented reality view of potentially hazardous phenomena in the real world, the application of cleanup agent to the hazardous phenomena, and the effect of cleanup agent on the hazardous phenomena.
